(19) United States
(12) Patent Application Publication
(10) Pub. No.: US 2025/0260251 A1
(43) Pub. Date: Aug. 14, 2025

(54) SYSTEMS AND METHODS FOR ADVANCED BATTERY CHARGING

(71) Applicants: Diana W. Baumohl, Chesterfield, MO (US); Charles E. Turco, Des Peres, MO (US)

(72) Inventors: Diana W. Baumohl, Chesterfield, MO (US); Charles E. Turco, Des Peres, MO (US)

(21) Appl. No.: 18/441,679

(22) Filed: Feb. 14, 2024

(51) Int. Cl. H02J 7/00

(52) U.S. Cl. CPC H02J 7/00712; H02J 7/00032; H02J 7/0042; H02J 7/0048

(57) ABSTRACT

A charging system is provided. The charging system includes a charging device including an electrical input for receiving electrical energy, at least one output for outputting electrical energy, and a communication interface; and a charger controller programmed to a) determine a current rate of charging for a connected device; b) provide electrical energy to the connected device based upon the current rate of charging; c) determine if the connected device accepts the electrical energy at the current rate of charging; and/or d) if the connected device does not accept the electrical energy at the current rate of charging, increase the current rate of charging until the connected device accepts the electrical energy at the current rate of charging.

### BACKGROUND

The field of the disclosure relates generally to advanced battery charging, and more particularly, to systems and methods for controlling the amount of charge and rate of charge delivered into a battery for portable devices.

The majority of charging devices for small portable electronics, including mobile phones, tablets and the like, support users with the fastest possible charge to a target device prioritizing short-term convenience versus longer term battery and device life. The majority of these electronic devices have embedded lithium-ion batteries (LIBs) that a user either cannot replace or are prohibitively expensive to replace. Furthermore, there are variations in the performance of different charging cables and charging devices.

A battery has its internal components that store charge. In particular, the battery has an array, or particle lattice, that stores charge and then releases charge upon demand of a device connected thereto. Heat may break down the particle lattice overtime as excessive heat energizes particles and may loosen, stretch, or break the lattice. A broken lattice has less storage potential than a new battery. Furthermore, abrupt or instantaneous demand upon a battery also affects the lattice as a large charge flow partially empties the lattice and increases the polarity of the remaining charge in the lattice. In addition, many available tools do not allow the user to control the attributes of the charging process. Accordingly, there is a need to extend the recharging life of batteries such as those for electronic devices.

### BRIEF DESCRIPTION

In one aspect, a charging system is provided. The charging system includes a charging device including an electrical input for receiving electrical energy, at least one output for outputting electrical energy, and a communication interface; and a charger controller programmed to a) determine a current rate of charging for a connected device; b) provide electrical energy to the connected device based upon the current rate of charging; c) determine if the connected device accepts the electrical energy at the current rate of charging; and/or d) if the connected device does not accept the electrical energy at the current rate of charging, increase the current rate of charging until the connected device accepts the electrical energy at the current rate of charging. The system may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a front view of an exemplary charger in accordance with at least one embodiment of the present disclosure.

FIG. 2 is a perspective view of the exemplary charger shown in FIG. 1.

FIG. 3 is a perspective view of an alternate exemplary charger.

FIG. 4 illustrates a simplified block diagram of an exemplary computer system for monitoring and controlling a charging process in accordance with at least one embodiment of the present disclosure.

FIG. 5 illustrates an exemplary configuration of a client computer device shown in FIG. 4, in accordance with one embodiment of the present disclosure.

FIG. 6 illustrates a flow chart of an exemplary computer implemented process 600 for monitoring and charging electronic devices shown in FIG. 4 at a minimum rate of charge (ROC) using the system shown in FIG. 4.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION

The present disclosure relates generally to advanced battery charging, and more particularly, to systems and methods for controlling the amount of charge and rate of charge delivered into a battery for portable devices.

Users, particularly those of mobile phones and portable devices, generally lack an understanding of how their devices work. In general, most users of portable electronics only know that something is wrong when their device does not perform the actions that they wish. Furthermore, many existing charging products primarily emphasize reaching maximum charge, i.e., fully charged, as fast as possible so that the device receiving the charge returns to function, fast.

Presently, lithium-ion batteries, or LIB, have the widest use as technology and materials for mobile device energy storage. Like other batteries, LIB begin to degrade over time due to repeated charging. The rate of degradation of LIB comes from environmental conditions and how users charge and use the devices that the LIB is housed in. Manufacturers of electronic devices do not provide consistent guidance and there currently are no industry standards in charging electronic devices. There can be a difference between what chargers put out in terms of electrical energy and what devices need to charge safely. Devices of different types may have different charging requirements. For example, a laptop has different charging requirements than a tablet or a smartphone, which have different charging requirements from each other. Furthermore, users may be unaware of these different charging requirements.

Accordingly, there are multiple different strategies for charging LIB and other battery devices. These strategies may include, but are not limited to, expediting to provide the fastest charge for the device, reduced charging rate to limit adverse effects on the battery, and/or charging to less than 100% to extend the life of the battery. The systems and methods described herein may be used to provide reduced charging rate to limit adverse effects on the battery and extend battery useful life.

The present disclosure allows a user who has an electronic device with an internal battery to deliver power to target device and to regulate the inflow of electricity to the battery so that the battery is charged at the minimum rate of charge (RoC) possible for that battery.

In the exemplary embodiment, the system determines the minimum rate of charge (ROC) that will allow an attached battery to charge. Furthermore, the system continually monitors the battery charging and updates the minimum ROC of the battery during the charging process. The minimum ROC of a battery is the minimum amount of current that may be provided to the battery and increase the state of charge of the battery receiving said charge.

In the exemplary embodiment, the charger attempts to start charging at a predetermined rate of charge. In some embodiments, the predetermined rate of charge is provided by the user. In other embodiments, the predetermined rate of charge was previously determined by a computing device using the systems and methods described herein. In further embodiments, the predetermined or starting rate of charge is further based upon variations of other attributes and/or parameters, such as, but not limited to, the current temperature and/or the number of prior recharging cycles.

Then the charger monitors the battery to determine if the battery is charging at that predetermined ROC. If the battery is not charging at that predetermined rate, then the charger increases its provided ROC and continues to monitor the state of charge of the battery. In some embodiments, the charger determines if the battery is accepting the provided ROC. The charger continues to increase the ROC provided to the battery until the battery accepts the provided energy and begins to charge. In the exemplary embodiment, the charger increases the ROC in a stepped manner, where each step includes a measured increase in the current provided to the battery. The charger notes the provided ROC and continues to monitor the battery to determine if the battery continues to charge. In some embodiments, the attributes of the battery may change based on different attributes of the battery. For example, if a battery heats up and/or has a different state of charge, then one or more attributes of the battery, such as minimum ROC may change over time. If during later monitoring, the battery stops accepting the charge from the charger, the charger increases the ROC in steps until the battery accepts the charge from the charger.

In some embodiments, after the battery has accepted a ROC for a predetermined period of time, the charger checks to see if a delay condition has been met. The delay parameter may be a period of time and/or a state of charge threshold, for example. While the delay parameter conditions/threshold has not been met, the charger continues to provide charge at the current ROC. For example, the delay parameter may be state of charge of the battery, where the condition is met when the state of charge reaches 20%, for example. The delay parameter may be set by the user and/or historical charging information about the individual battery and/or other batteries similar to the one charging. In some embodiments, the delay parameter may include a plurality of thresholds. For example, the delay parameter may cause the charger to attempt to reduce the ROC at a state of charge of 20%, 40%, 60%, and/or 80%.

Once the delay parameter conditions/threshold has been met, the charger reduces the ROC by one or more steps and determines if the battery accepts that reduced ROC. If the battery accepts the reduced ROC, then the charger further reduces the ROC until the battery no longer accepts the further reduced ROC. Then the charger returns to a previously accepted minimum ROC to charge the battery. The system continues to ensure that the battery is charged at the minimum ROC allowed by the battery.

In some embodiments, the step-up amount and the step-down amount are the same. In other embodiments, the step-up amount and the step-down amount are different. The charger then determines if the newly lowered ROC is accepted by the battery. If accepted, then the charger continues to provide charge at that rate. If the charge is not accepted, then the charger steps-up the ROC. In some embodiments, the charger returns the ROC to the previously accepted amount. In this way the charger charges the device at the lowest ROC possible during the entire charging process.

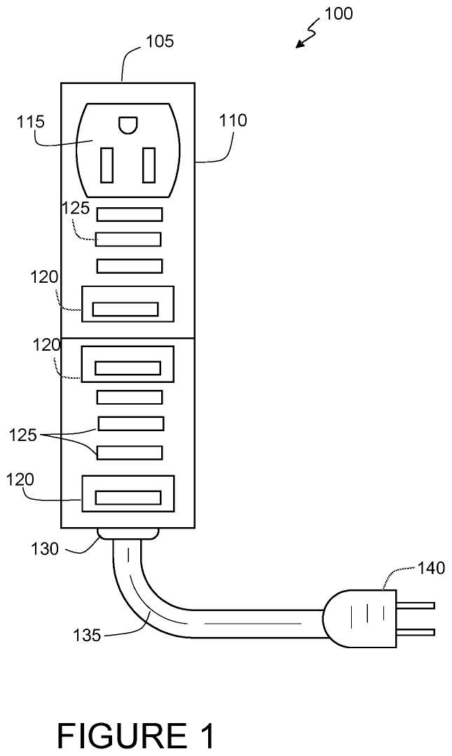

FIGS. 1-3 illustrate two exemplary configurations for the charging device described herein. One having skill in the art would understand that other configurations may also be used with the systems and methods described herein to perform the features and functions described herein.

FIG. 1 is a front view of an exemplary charger 100 in accordance with at least one embodiment of the present disclosure. Charger 100 as shown in FIG. 1 includes an elongated power strip 105, which acts as an interface device as described herein. Power strip 105 includes a housing 110 that holds at least one outlet 115 and at least one USB socket 120 for connecting devices to charge. Power strip 105 is configured to provide electrical energy through the at least one outlet 115 and the at least one USB socket 120 to connected devices. The USB socket 120 may include any type of USB or charging port, such as, but not limited to, USB Type A, USB Type B, USB Type C, USB Mini B, USB Micro B, USB 3.0 Type A, USB 3.0 Type B, USB 3.0 Micro B, and/or lightning connector.

The power strip 105 also includes a one or more visible gauges 125, where the visible gauges 125 may defines the current state of charge (SoC) for the corresponding connected device that is connected to the corresponding outlet 115 or USB socket 120. While the visible gauges 125 may be LED (light emitting diode) numerical displays, one having skill in the art would understand that other displays may be used to display information to the user. These may include, but are not limited to, LED indicator lights, OLED (organic light-emitting diode) screen, LCD (liquid crystal display) screen, and/or any other type of display to provide the information to the user. The connected device may be an electronic device, such as a mobile phone, a tablet computer, and the like.

The strip 105 may also include a surge protector 130 generally centered upon an end of the strip 105 and a cord 135 extending outwardly through the protector 130. The cord 135 has a desirable length such as between three to eight feet where the length may be limited from power loss. Opposite the protector 130, the cord 135 ends with a plug 140. The plug 140 connects the strip 105 to a source of electrical charge, such as a wall outlet with utility service, a generator, a line from solar power, a battery pack, an electric vehicle, and/or any available power source. In some further embodiments, the charger 100 includes a battery for holding charge to provide through the outlets 115 or USB sockets 120.

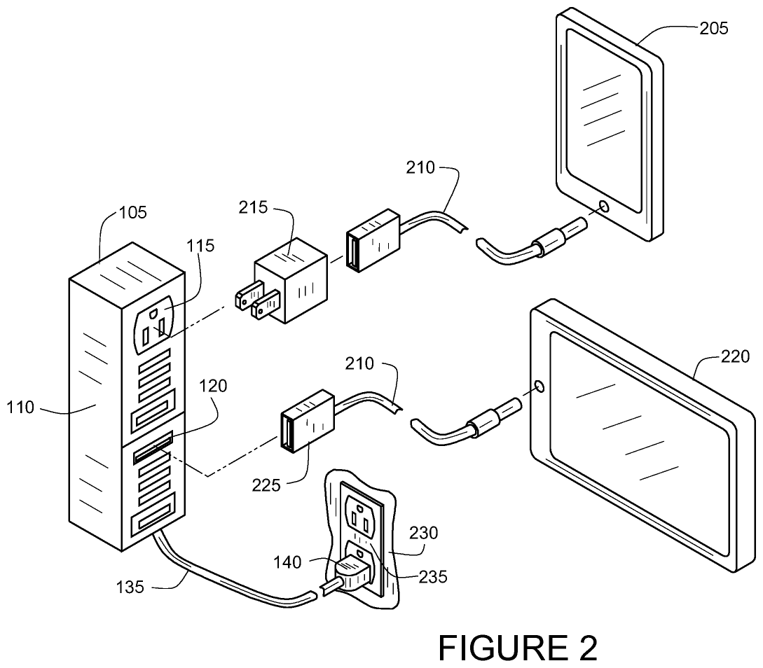

FIG. 2 is a perspective view of the exemplary charger 100 (shown in FIG. 1). FIG. 2 shows a perspective view of the charger 100 with the strip 105 deployed for usage. The strip 105 has its cord 135 extended and its plug 140 having its prongs (not shown) inserted into an existing outlet 235 in a wall 230, as in a residential or an office setting. The strip's outlet 115 then receives a charging cube 215, or USB adapter 225, that connects with a charging cable 210 usually with a USB end and an opposite fitted end. The fitted end then connects with an electronic device such as a mobile phone 205. Also, the strip's USB socket 120 connects with a charging cable 210 usually with a USB end 225 and an opposite fitted end. The fitted end here then connects to another electronic device such as a tablet computer 220 or mobile phone 205. In some embodiments, the fitted end is a specialized connector. In other embodiments, the fitted end 225 is a charging port, such as, but not limited to, USB Type A, USB Type B, USB Type C, USB Mini B, USB Micro B, USB 3.0 Type A, USB 3.0 Type B, USB 3.0 Micro B, lightning connector, and/or any other desired connector.

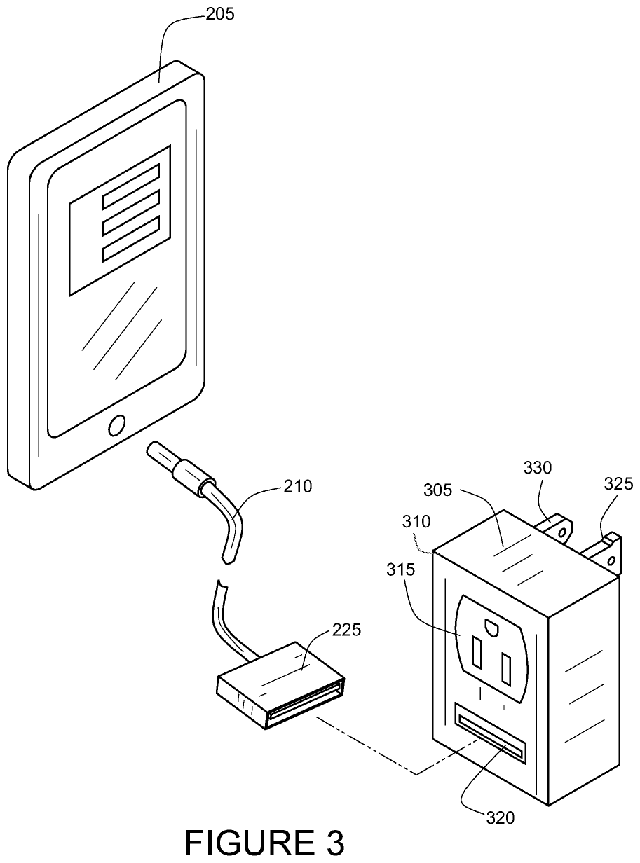

FIG. 3 is a perspective view of an alternate exemplary charger 305. FIG. 3 describes a perspective view of the block charger 305 with the block form deployed for usage towards the right. Block charger 305 has its housing 310 with the prongs 325, 330 extended to the right towards an existing outlet 235 (shown in FIG. 2), as in a residential or an office setting. The block's outlet 315 may receive a charging cube or other adapter, not shown, for an existing charging cable. Here in this figure though, the block's USB socket 320 receives a charging cable 210 with its USB end as at 225 inserting into the socket 320 and an opposite fitted end. The fitted end then connects to another electronic device such as a mobile phone 205. In some embodiments, the fitted end is a specialized connector. In other embodiments, the fitted end is a charging port, such as, but not limited to, USB Type A, USB Type B, USB Type C, USB Mini B, USB Micro B, USB 3.0 Type A, USB 3.0 Type B, USB 3.0 Micro B, and/or lightning connector.

Charger 100 and Charger 305 may also include a wireless connection (not shown). The wireless connections allow the chargers 100 and 305 to communicate with remote computer devices to provide charging information about the connected devices and to receive parameters for charging those devices. Some examples of the wireless connection include, but are not limited to, Wi-Fi, Bluetooth, NFC (Near Field Communication), and/or any other wireless system that allows the system to work as described herein.

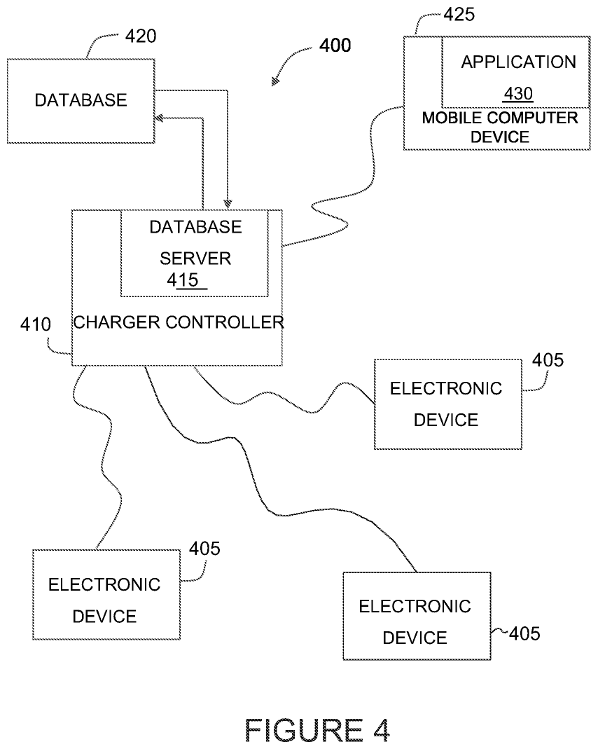

In some embodiments, the charger 100 or 305 is modular and allows different outlets 115/315 and/or charging ports 120/320 to be added and/or removed from the modular charger. The additional modules are configured to be electrically connected to the rest of the charger 100 or 305 to provide charge to the connected electronic devices 205 and 220. Furthermore, the additional modules are in communication with the charger controller 410 (shown in FIG. 4) to control the rate of charge provided by the added outlet 115/315 and/or charging port 120/320.

FIG. 4 depicts a simplified block diagram of an exemplary computer system 400 for monitoring and controlling a charging process in accordance with at least one embodiment of the present disclosure. In the exemplary embodiment, system 400 may be used for controlling the charging of electronic devices 405. In the exemplary embodiment, the charging of the electronic devices 405 is through a charger 100 and 305 (shown in FIGS. 1 and 3), which provides throttled electrical current to the connected electronic devices 405 to charge the battery(s) of those devices.

In the exemplary embodiment, the system 400 is configured to provide for charging devices 405 at the minimum charging rate to extend the useful life of a given device 405 over the fastest possible (daily) charge to reach a maximum charge state.

In the exemplary embodiment, the system 400 provides users of portable electronic devices 405 with the ability to charge those devices 405 at the minimum rate of charge (RoC) in order to lengthen the useful life of the LIB. This system 400 prolongs battery life in electronic devices 405 such as cell phones, tablets, laptops or remotely managed devices or other devices that rely on LIBs. System 400 determines the minimum rate of charge of a device 405 by starting at a predetermined starting ROC.

In some embodiments, the predetermined rate of charge is provided by the user. In other embodiments, the predetermined rate of charge was previously determined by a computing device using the systems and methods described herein. In further embodiments, the predetermined or starting rate of charge is further based upon variations of other attributes and/or parameters, such as, but not limited to, the current temperature and/or the number of prior recharging cycles.

Then the system 400 determines if the device 405 accepts the charge at that ROC. In some embodiments, the system 400 determines the acceptance of the charge by the device 405 accepting the charge and completing the circuit. In other embodiments, the system 400 determines the acceptance of the charge by monitoring the current state of charge of the device 405 to determine if it increases. If the device 405 does not accept the starting ROC, then the system 400 increases the ROC in a stepped manner until the device 405 accepts the charge.

The system 400 notes the provided ROC and continues to monitor the device 405 to determine if the device 405 continues to charge. In some embodiments, the charging attributes of the device 405 may change based on different attributes of the battery. For example, if a battery heats up and/or has a different state of charge, then one or more charging attributes of the battery, such as minimum ROC may change over time. If during later monitoring, the battery stops accepting the charge from the system 400, the system 400 increases the ROC in steps until the battery accepts the charge from the system 400.

In some embodiments, after the battery has accepted a ROC for a predetermined period of time, the system 400 reduces the ROC by one or more steps and determines if the battery accepts that reduced ROC. If the battery accepts the reduced ROC, then the system 400 further reduces the ROC until the battery no longer accepts the further reduced ROC. Then the system 400 returns to a previously accepted minimum ROC to charge the battery. The system 400 continues to ensure that the battery is charged at the minimum ROC allowed by the battery.

In the exemplary embodiment, electronic devices 405 are powered by rechargeable batteries, such as, but not limited to, including lead-acid, zinc-air, nickel-cadmium (NiCd), nickel-metal hydride (NiMH), lithium-ion (Li-ion), lithium iron phosphate (LiFePO4), lithium-ion polymer (Li-ion polymer), and any other rechargeable battery. In the exemplary embodiment, electronic devices 405 electrically connect to the charger 100 or 305 via a wired or wireless connection to receive charge from the charger 100 and 305. In some embodiments, the electronic devices 405 are in communication with the charger controller 410 via a wired connection, such as the wired connection for receiving electrical charge. In other embodiments, the electronic devices 405 are in communication with the charger controller 410 via a wireless connection, such as, but not limited to, Wi-Fi, Bluetooth, NFC, etc. Examples of electronic devices 405 include, but are not limited to, a laptop computer, a personal digital assistant (PDA), a cellular phone, a smartphone, a tablet, a phablet, wearable electronics, smart watch, earbuds, electronic toys, a power bank, power tools, an electric vehicle, and/or other electronic, battery-powered devices.

In at least one embodiment, the charger controller 410 is a part of charger 100 and 305. In other embodiments, charger controller 410 is in communication with the charger 100 and 305. The charger controller 410 throttles typical US electrical utility current delivered at a wall outlet through resistance and impedance. In the exemplary embodiment, charger controller 410 is a computer that allows remote computer devices, such as, but not limited to electronic device 405 and mobile computer device 425 to connect using a web browser or a software application, which enables electronic device 405 and/or mobile computer device 425 to access the charger controller 410 using the Internet or other network. More specifically, charger controller 410 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Charger controller 410 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. The charger controller 410 may be remote from the charger 100 and 305 and cloud-based or the charger controller 410 may be located at the charger 100 and 305.

A database server 415 may be communicatively coupled to a database 420 that stores data. In one embodiment, database 420 may include battery profiles, charging parameters, and/or user preferences. In the exemplary embodiment, database 420 may be stored remotely from charger controller 410. In some embodiments, database 420 may be decentralized. In the exemplary embodiment, a user may access database 420 via mobile computer devices 425 by logging onto charger controller 410, as described herein.

Mobile computer devices 425 may also execute an application 430. Mobile computer devices 425 may be configured to execute application 430 to receive data from charger controller 410 and transmit data to charger controller 410. Mobile computer device 425 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Mobile computer device 425 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, mobile computer device 425 is configured to execute application 430 to communicate with charger controller 410. In these embodiments, the application 430 receives charging status information from the charger controller 410.

A further embodiment of the disclosure has two primary components: 1) the above-described charger 100 and 305 that delivers and regulates the charge delivered to connected electronic devices 405, and 2) a charger controller 410 that controls the rate of charge delivered to the connected electronic devices 405. In some embodiments, the charger controller 410 is a part of the charger 100 and 305. In other embodiments, the charger controller 410 is remoted from the charger 100 and 305, such as in the cloud.

The above system 400 may be used in multiple different manners to provide charging power to these electronic devices 405. In some embodiments, the system 400 is configured to allow the user to provide the predetermined starting ROC for the connected device 405, such as via the application 430 or an input on the charger 100. In still further embodiments, the system 400 is also configured to allow the user to set one or more additional attributes, including, but not limited to, the step size between ROCs, a maximum ROC, the waiting period of time before the system 400 tries to reduce the ROC, and/or the waiting period of time to determine if the device 405 is accepting the charge.

In another embodiment, the electronic device 405 is wired into the charger 100 and 305 and the electronic device 405 also includes an application. In this embodiment, the electronic device 405 includes all transformer and protection capabilities inside device 405.

The Application 430 and/or charger controller 410 are designed to run on either a mobile or PC platform and manages the connection between a user's device and the charger 100 and 305. The Application 430 and/or charger controller 410 allows a user to control the charging of their electronic device 405 in several different ways. Various statistics of the user's device, including the state-of-charge (SoC) and rate-of-charge (RoC), are communicated from the Application 430 and/or charger controller 410 to the charger 100 and 305. These statistics allow the charger 100 and 305 to adjust its status to meet the charging parameters set by the user. Furthermore, the Application 430 and/or charger controller 410 are designed to run in the background while the user's electronic device 405 is connected to the charger 100 and 305, in order to continuously send updates to the charger 100 and 305. Additionally, the Application 430 and/or charger controller 410 are capable of calculating and providing estimates to users about parameters such as time to charge completion.

The application 430 provides charging parameters from the user to the charger controller 410 and provides attributes of the electronic device 405 being charged to the user. The attributes include information about the health and status of the battery and/or the electronic device 405. The information may include, but is not limited to, current battery charge, maximum battery charge, maximum potential battery charge, maximum charging rate for electronic device, minimum charging rate for electronic device, time to maximum battery charge, battery temperature, and/or other information. In some embodiments, some of this information may be provided via indicators, (i.e., visible gauges 125 (shown in FIG. 1).

The system 400 is informed by a database 420 of popular target devices with battery capacity (mAh) and recommended min and max RoCs and min and max SoCs. The Application 430 and/or charger controller 410 will use this database 420 to provide estimates of time to complete charging for a given electronic device 405 as well as to set optimal minimum RoC.

In at least one embodiment, the charger 100 and 305 contains a pre-programmed microcontroller which is capable of adjusting the powered-on status and RoC of the charger 100 and 305. The microcontroller establishes a wireless connection or can be used via a wired connection with the user's mobile computer device 425 which allows it to receive periodic updates from the device 405.

When the charger 100 and 305 receives the signal from the user's mobile computer device 425 to begin the charging process, it first reads the user-set parameters, such as, but not limited to, starting ROC, RCO step value, Max SoC, and desired time to completion, and saves these parameters in non-volatile memory. The microcontroller enables the charger 100 and 305 at a specified predetermined RoC and monitors to determine if the connected device 405 accepts the charge. In some embodiments, the charger 100 and 305 determines that the device 405 accepts the charge. In other embodiments, the user's device's 425 informs the charger 100 and 305 that the charge has been accepted.

In the exemplary embodiment, the application 430 and charger controller 410 use Bluetooth Low Energy (BLE) technology to establish a connection with the charger 100 and 305 when it is first connected. When using the charger 100 and 305 for the first time, the application 430 and charger controller 410 provide an onboarding process which helps users pair the charger 100 and 305 with their mobile computer device 425. Once the device 425 is paired, the charger 100 and 305 will automatically connect to the user's mobile computer device 425 once it is plugged in.

During the charging process, the application 430 and/or the charger controller 410 will periodically send updates to the charger 100 and 305 containing information about the device's current SoC. Additionally, the application 430 and/or the charger controller 410 will determine the ROC used at different points during the charging of the device 405. The application 430 and/or the charger controller 410 will then store these values. In some embodiments, the application 430 and/or the charger controller 410 use the stored ROC values from past charging sessions to determine the starting ROC value and/or the ROC step value.

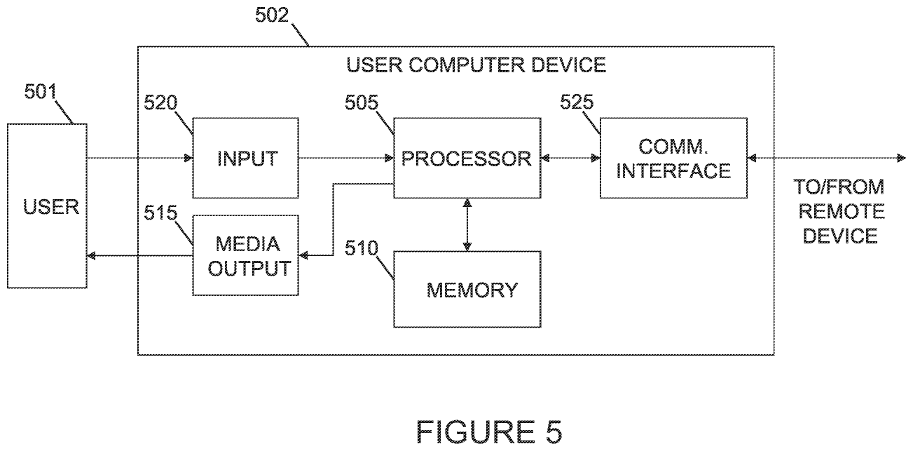

FIG. 5 depicts an exemplary configuration of mobile computer device 425 shown in FIG. 4, in accordance with one embodiment of the present disclosure. User computer device 502 may be operated by a user 501. User computer device 502 may include, but is not limited to, mobile computer devices 425, electronic device 405, charger controller 410 (all shown in FIG. 4), charger 100 (shown in FIG. 1), and charger 305 (shown in FIG. 3). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for displaying charging status. In some embodiments, user computer device 502 may include an input device 520 for receiving input from user 501. User 501 may use input device 520 to, without limitation, provide charging parameters.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as charger controller 410. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from charger controller 410. A client application allows user 501 to interact with, for example, charger controller 410. For example, instructions may be stored by a cloud service, and the output of the execution of the instructions sent to the media output component 515.

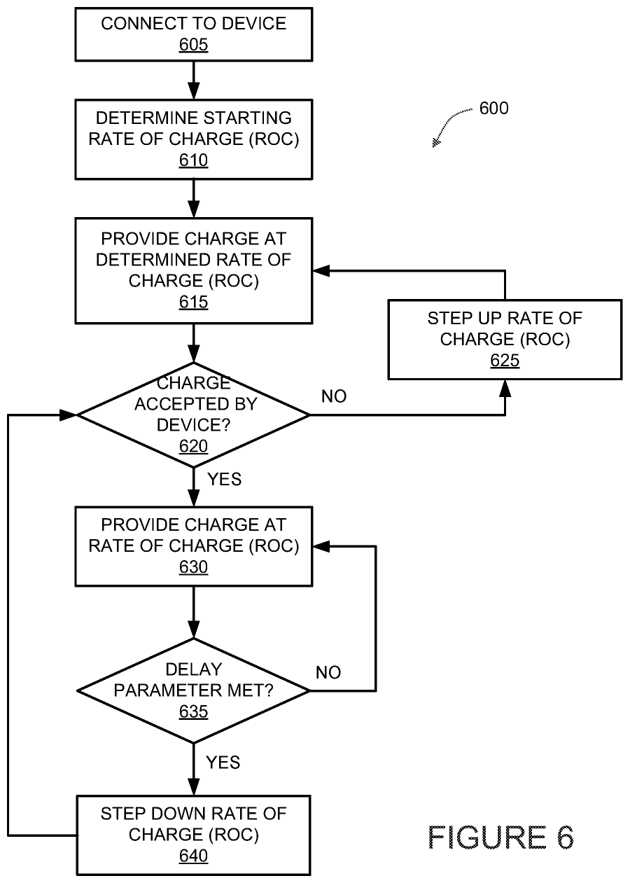

Processor 505 executes computer-executable instructions for implementing aspects of the disclosure. In some embodiments, the processor 505 is transformed into a special purpose microprocessor by executing computer-executable instructions or by otherwise being programmed. For example, the processor 505 may be programmed with the instruction such as illustrated in FIG. 6.

In some embodiments, user computer device 502 may include, or be in communication with, one or more applications, such as application 430 (shown in FIG. 4). User computer device 502 may be configured to receive data from the one or more sensors and store the received data in memory area 510. Furthermore, user computer device 502 may be configured to transmit the sensor data to a remote computer device, such as charger controller 410, through communication interface 525.

FIG. 6 illustrates a flow chart of an exemplary computer implemented process 600 for monitoring and charging electronic devices 405 (shown in FIG. 4) at a minimum rate of charge (ROC) using the system 400 (shown in FIG. 4). Process 600 may be implemented by a computing device, for example charger controller 410 (shown in FIG. 4). In the exemplary embodiment, charger controller 410 may be in communication with a mobile computer device 425 (shown in FIG. 4), one or more electronic devices 405, charger 100 (shown in FIG. 1), and/or charger 305 (FIG. 3).

In the exemplary embodiment, the charger 100 and/or 305 connects 605 to an electronic device 405 to charge. In the exemplary embodiment, the charger controller 410 determines that the charger 100 and/or 305 has connected 605 to a device 405.

In the exemplary embodiment, the charger controller 410 determines 610 a starting rate of charge (ROC) for charging the device 405. The starting ROC is determined to be a prediction for the minimum ROC that will allow the device 405 to charge. In some embodiments, the starting ROC is set by the user. In other embodiments, the starting ROC is based on the connected device type. For example, a smartphone 205 (shown in FIG. 2) may have a smaller starting ROC than a tablet 220 (shown in FIG. 2) or a laptop. In other embodiments, the charger controller 410 determines 610 the starting ROC based on historical charging information and detected minimum ROCs. For example, the charger controller 410 may store the minimum accepted ROC for a battery and/or electronic device 405. The charger controller 410 may also store other attributes of that battery and/or electronic device 405, such as temperature, number of prior recharging cycles, starting state of charge, and/or any other attributes desired. In the exemplary embodiment, the starting ROC is for current and is provided in amps.

In the exemplary embodiment, the charger 100 and/or 305 provides 615 a charge to the device 405 at the determined ROC. In some embodiments, the charger controller 410 instructions the charger 100 and/or 305 to provide 615 the charge to the device 405 at the determined ROC.

Then the charger controller 410 determines 620 if the charge is being accepted by the device 405. In some embodiments, the charger 100 and/or 305 determines that the charge is being accepted by the current being accepted by the device. In other embodiments, the charger controller 410 determines that the charge is being accepted by the device 405 by detecting an increase in the state of charge of the device 405. If the device 405 is not accepting the charge, then the charger controller 410 steps-up 625 the rate of charge and instructs the charger 100 and/or 305 to provide 615 the increased ROC. In the exemplary embodiment, the step-up value is 0.1 amps. In other embodiments, the step-up value is 1 mA. One having skill in the art would understand that the step-up value could be any increase in the amount of current desired. In some embodiments, the step-up value is set by the user. In other embodiments, the step-up value is set by the charger controller 410 based upon the device type and/or the historical charging information. The charger controller 410 continues to step-up 625 the ROC until the charge is accepted 620 by the device 405.

Once the determination 620 is that the charge is accepted by the device 405, the charger 100 and/or 305 and the charger controller 410 continues to provide 630 charge at the current ROC. Next the charger 100 and/or 305 and the charger controller 410 determines 635 if a delay parameter has been met. The delay parameter may be a period of time and/or a state of charge threshold, for example. While the delay parameter conditions/threshold has not been met, the charger 100 and/or 305 and the charger controller 410 continues to provide 620 charge at the current ROC. For example, the delay parameter may be state of charge of the battery, where the condition is met when the state of charge reaches 20%, for example. The delay parameter may be set by the user and/or historical charging information about the individual battery and/or other batteries similar to the one charging. In some embodiments, the delay parameter may include a plurality of thresholds. For example, the delay parameter may cause the charger 100 and/or 305 and the charger controller 410 attempt to reduce the ROC at a state of charge of 20%, 40%, 60%, and/or 80%.

Once the delay parameter conditions/threshold has been met, the charger controller 410 steps down 640 the ROC. In some embodiments, the step-up amount and the step-down amount are the same. In other embodiments, the step-up amount and the step-down amount are different. The charger controller 410 then determines 620 if the newly lowered ROC is accepted by the device 405. If accepted, then the charger 100 and/or 305 continues to provide 630 charge at that rate. If the determination 620 is that the charge is not accepted, then the charger controller 410 steps-up 625 the ROC. In some embodiment, the charger controller 410 returns the ROC to the previously accepted amount. In this way the charger controller 410 charges the device 405 at the lowest ROC possible during the entire charging process.

In some embodiments, the charger controller 410 is configured to recognize the battery being charged. The charger controller 410 may then set the starting ROC based on past charging information about that battery. In other embodiments, the charger controller 410 may adjust the starting ROC based upon one or more parameters of the battery, such as, but not limited to, current temperature and/or number of prior recharging cycles. The starting ROC may also be set based on the nature of the battery and/or the electronic device 405. For example, an electric vehicle would have a higher starting ROC than a smartphone or a smartwatch.

At least one of the technical problems addressed by this system may include: (i) lessens battery degradation; (ii) extends battery life; (iii) reduces energy cost; (iv) conserves electrical power; (v) provides optimal battery life; (vi) enables the collection of data to optimize charging over time; (vii) tailors charging speed to device being charged; and/or (viii) charge the device at the minimum ROC possible.

The methods and systems described herein may be implemented using computer programming or engineering techniques including computer software, firmware, hardware, or any combination or subset thereof, wherein the technical effects may be achieved by performing at least one of the following steps: a) determine a current rate of charging for a connected device; b) provide electrical energy to the connected device based upon the current rate of charging; c) determine if the connected device accepts the electrical energy at the current rate of charging; d) if the connected device does not accept the electrical energy at the current rate of charging, increase the current rate of charging until the connected device accepts the electrical energy at the current rate of charging; e) determine a starting rate of charging for the connected device; f) provide electrical energy to the connected device based upon the starting rate of charging; g) determine if the connected device accepts the electrical energy at the starting rate of charging; h) if the connected device does not accept the electrical energy at the starting rate of charging, increase the current rate of charging from the current rate of charging; i) determine the starting rate of charge based upon a device type of the connected device; j) determine the starting rate of charge based upon a plurality of historical charging information; k) determine the starting rate of charge based upon one or more user preferences; l) increase the current rate of charging by a step amount; m) after increasing the current rage of charging by a step amount determine if the connected device accepts the electrical energy at the increased current rate of charging; n) if the connected device does not accept the electrical energy at the increased current rate of charging, increase the current rate of charging by another step amount; o) reduce the current rate of charging by a step amount; p) determine if the connected device accepts the electrical energy at the decreased current rate of charging; q) increase the rate of charging if the connected device does not accept the electrical energy at the decreased current rate of charging; r) reduce the current rate of charging by a step amount after a predetermined period of time of providing electrical energy at the current rate of charging; s) reduce the current rate of charging by a step amount after a threshold state of charge for the connected device has been reached; t) reduce the current rate of charging by a step amount after a delay parameter condition has been met; u) wherein the charger controller is housed in a housing of the charging device; v) wherein the charger controller is in communication with the charging device via a wireless connection; w) wherein an application on the mobile computer device interfaces between a user and the charger controller; x) wherein an output of the at least one output is an outlet; y) wherein an output of the at least one output is an USB connector; z) wherein an output of the at least one output is a lightning connector; aa) wherein the charging device is configured to be plugged into a wall outlet; and/or bb) wherein the charging device is lightweight and portable.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A charging system comprising:
a charging device including an electrical input for receiving electrical energy, at least one output for outputting electrical energy, and a communication interface; and
a charger controller including at least one processor in communication with at least one memory device and in communication with the charging device, wherein the at least one processor is programmed to:
determine a current rate of charging for a connected device;
provide electrical energy to the connected device based upon the current rate of charging;
determine if the connected device accepts the electrical energy at the current rate of charging; and
if the connected device does not accept the electrical energy at the current rate of charging, increase the current rate of charging until the connected device accepts the electrical energy at the current rate of charging.

2. The charging system of claim 1, wherein the at least one processor is further programmed to:
determine a starting rate of charging for the connected device;
provide electrical energy to the connected device based upon the starting rate of charging;
determine if the connected device accepts the electrical energy at the starting rate of charging; and
if the connected device does not accept the electrical energy at the starting rate of charging, increase the current rate of charging from the current rate of charging.

3. The charging system of claim 2, wherein the at least one processor is further programmed to determine the starting rate of charging based upon a device type of the connected device.

4. The charging system of claim 2, wherein the at least one processor is further programmed to determine the starting rate of charging based upon a plurality of historical charging information.

5. The charging system of claim 2, wherein the at least one processor is further programmed to determine the starting rate of charging based upon one or more user preferences.

6. The charging system of claim 1, wherein the at least one processor is further programmed to increase the current rate of charging by a step amount.

7. The charging system of claim 6, wherein the at least one processor is further programmed to after increasing the current rate of charging by a step amount determine if the connected device accepts the electrical energy at the increased current rate of charging.

8. The charging system of claim 7, wherein the at least one processor is further programmed to if the connected device does not accept the electrical energy at the increased current rate of charging, increase the current rate of charging by another step amount.

9. The charging system of claim 1, wherein the at least one processor is further programmed to reduce the current rate of charging by a step amount.

10. The charging system of claim 9, wherein the at least one processor is further programmed to determine if the connected device accepts the electrical energy at the decreased current rate of charging.

11. The charging system of claim 10, wherein the at least one processor is further programmed to increase the current rate of charging if the connected device does not accept the electrical energy at the decreased current rate of charging.

12. The charging system of claim 9, wherein the at least one processor is further programmed to reduce the current rate of charging by a step amount after a predetermined period of time of providing electrical energy at the current rate of charging.

13. The charging system of claim 9, wherein the at least one processor is further programmed to reduce the current rate of charging by a step amount after a threshold state of charge for the connected device has been reached.

14. The charging system of claim 9, wherein the at least one processor is further programmed to reduce the current rate of charging by a step amount after a delay parameter condition has been met.

15. The charging system of claim 1, wherein the charger controller is housed in a housing of the charging device.

16. The charging system of claim 1, wherein the charger controller is in communication with the charging device via a wireless connection.

17. The charging system of claim 1, wherein an application on a mobile computer device interfaces between a user and the charger controller.

18. The charging system of claim 1, wherein an output of the at least one output is an outlet.

19. The charging system of claim 1, wherein an output of the at least one output is an USB connector.

20. The charging system of claim 1, wherein an output of the at least one output is a lightning connector.

21. The charging system of claim 1, wherein the charging device is configured to be plugged into a wall outlet.

22. The charging system of claim 1, wherein the charging device is lightweight and portable.
